(19) United States
(12) Patent Application Publication
(10) Pub. No.: US 2025/0106682 A1
(43) Pub. Date: Mar. 27, 2025

(54) UE INFORMATION REPORTING AND PACKET DELAY MANAGEMENT IN WIRELESS COMMUNICATION

(71) Applicant: ZTE Corporation, Shenzhen (CN)

(72) Inventors: Xiubin SHA, Shenzhen (CN); He HUANG, Shenzhen (CN); Bo DAI, Shenzhen (CN); Ting LU, Shenzhen (CN); Yuan GAO, Shenzhen (CN)

(21) Appl. No.: 18/975,448

(22) Filed: Dec. 10, 2024

Related U.S. Application Data
(63) Continuation of application No. PCT/CN2022/129607, filed on Nov. 3, 2022.

(51) Int. Cl. H04W 28/02; H04W 72/52

(52) U.S. Cl. CPC H04W 28/0278; H04W 72/52

(57) ABSTRACT

Methods, apparatus, and systems that relate to UE information reporting and packet delay management technique in communication systems. In one example aspect, a method for digital communication includes transmitting, by a wireless device, a signal including a buffer size reporting information to a first communication device, wherein the buffer size reporting information comprises an identity information, a buffer size information, and a time information.

### CROSS-REFERENCE TO RELATED APPLICATION

This application is a continuation and claims priority to International Application No. PCT/CN2022/129607, filed on Nov. 3, 2022, the disclosure of which is hereby incorporated by reference herein in its entirety.

### TECHNICAL FIELD

This invention is related to the UE information reporting and packet delay management technique in communication systems.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, rate matching design for polar coding, PAC coding and/or other pre-transformed polar coding schemes.

In one example aspect, a first wireless communication method is disclosed. The method includes transmitting, by a wireless device, a signal including a buffer size reporting information to a first communication device, wherein the buffer size reporting information comprises an identity information, a buffer size information, and a time information.

In another example aspect, another method of wireless communication is disclosed. The method includes receiving, by a first communication device, a signal including a buffer size reporting information sent by a wireless device, wherein the buffer size reporting comprises an identity information, a buffer size information, and a time information; and determining, by the first communication device, a resource allocation for the wireless device based on the buffer size reporting information.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIG. 1 shows a diagram for an example of mapping between QoS flow and logical channel.

FIG. 2 shows a diagram of an example of Buffer size and related time information report MAC CE.

FIGS. 2A-2B show diagrams of other examples of Buffer size and related time information report MAC CE.

FIG. 3 shows an example of (AN) packet delay budget and/or PDU set delay budget transmitting structure.

FIGS. 3A-3B show other examples of (AN) packet delay budget and/or PDU set delay budget transmitting structure.

FIG. 3C shows an example of time threshold transmitting structure.

FIG. 4 shows an exemplary block diagram of a hardware platform that may be a part of a network device or a communication device.

FIG. 5 shows an example of network communication including a base station (BS) and user equipment (UE) based on some implementations of the disclosed technology.

FIG. 6 is a flowchart representation of a method for digital communication in accordance with one or more embodiments of the present technology.

FIG. 7 is a flowchart representation of another method for digital communication in accordance with one or more embodiments of the present technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 5G terminology is used for the sake of clarity of explanation, but the techniques disclosed in the present document are not limited to 5G technology only and may be used in wireless systems that implemented other protocols.

This application discloses methods and apparatuses related to reporting buffer size and related delay budget information in wireless communication systems.

In radio communication system, e.g., LTE, NR or 6G system, core network may send the following delay budget to radio network element (e.g., eNB, gNB):
Packet delay budget (PDB): which indicates an upper bound for the time that a packet may be delayed between the UE and the N6 termination point at the user plane function (UPF).
Core Network Packet Delay Budget (CN PDB): which represents the delay between any N6 termination point at the UPF and radio network element.
PDU set delay budget (PSDB): which indicates an upper bound for the time that a PDU set may be delayed between the UE and the N6 termination point at the user plane function (UPF).
Core Network PDU set delay budget (CN PSDB): which represents the PDU set delay between any N6 termination point at the UPF and radio network element. In some cases, the CN PSDB can be substitute by CN PDB (e.g., with the same value).

Based on the PDB and CN PDB, 5G Access Network Packet Delay Budget (5G-AN PDB) can be determined: which indicates an upper bound for the time that a packet may be delayed between UE and radio network element and is determined by subtracting CN PDB from a PDB. Similarly, 5G Access Network Packet Delay Budget (5G-AN PSDB) can be determined by PSDB minus CN PDDB.

For UL packet delivery, the following steps are usually used:
UE reports the buffer size level (e.g., reports the UL packets amount in the UE buffer by BSR MAC CE) to radio network element;
radio network element allocates UL grant for the UE based on the BSR reported and the AN PDB;
UE sends the UL packets over the UL grant allocated.

Based on the legacy procedure, when radio network element allocates UL grant for the UE, it cannot know how long time the UL packet is buffered before sending the BSR, and remaining AN PDB can be used for the transmission. If the radio network element allocates the UL grant based on AN PDB (e.g., not considering the time duration that the UL packet is buffered in UE), the UL packet transmission delay (e.g., the delay from the packet arrives at UE PDCP or PDCP upper SAP to the packet arrives to the radio network element) may exceed the AN PDB and the UL transmission cannot satisfy the service requirement.

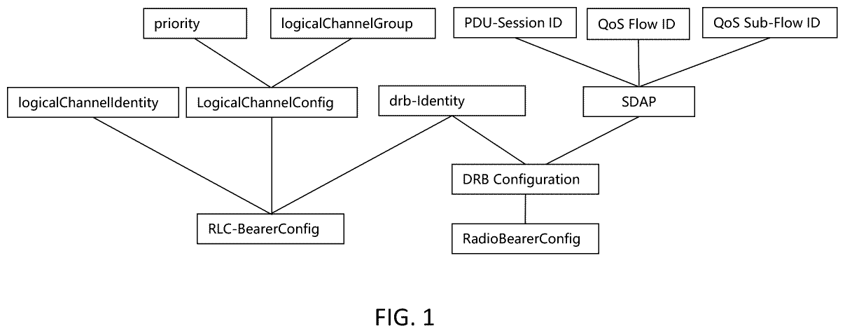

And, based on the current specification, PDB and CN PDB are configured per QoS flow, but BSR is reported per logical channel group (LCG), and one LCG may include multiple logical channels. The mapping between QoS flow and logical channel is shown in FIG. 1.

Thus, even UE reports the remaining AN PDB per LCG, the radio network element cannot decide which logical channel the remaining AN PDB corresponds to. And UE cannot know the PDB for the non-Standardized 5QI case and cannot decide the remaining AN PDB.

Furthermore, when UE receives the UL grant, and there are multiple logical channels with data to be transmitted, the UE should prioritize the logical channels (Logical Channel Prioritization, LCP) and select the one or more logical channels with data to transmit. Based on the current specification, only PBR (Prioritized Bit Rate) and the elapsed time that the data is buffered in UE, the remaining PDB is not considered. Thus, the logical channel with smaller PDB will not be prioritized for transmission, and the UL packet transmission delay (e.g., the delay from the packet arrives UE PDCP or PDCP upper SAP to the packet arrives to the radio network element, e.g., radio network element PDCP) may exceed the AN PDB and the UL transmission cannot satisfy the service requirement.

To overcome these issues, among other issues, solutions are provided.

### Introduction to Embodiments

This section discloses multiple examples related to UE information reporting and packet delay management technique in wireless communication systems. The details of the examples will be explained in the following embodiments.

### Embodiment 1

This section discloses examples involving frame design involving time information and BSR.

Based on the PDB and CN PDB, 5G Access Network Packet Delay Budget (5G-AN PDB) can be determined: which indicates an upper bound for the time that a packet may be delayed between UE and radio network element and is determined by subtracting CN PDB from a PDB. A radio network element can also determine a packet discard timer per DRB based on AN PDB, or PDU set discard timer per DRB based on AN PSDB.

As discussed in the background section, a radio network element cannot know how long a UL packet is buffered in the UE side based on the legacy procedure. If the radio network element allocates the UL grant based on AN PDB (e.g., not considering the time duration that the UL packet is buffered in UE) or packet discard timer, the UL packet transmission delay (e.g., the delay from the packet arrives UE PDCP to the packet arrives to the radio network element, e.g. radio network element PDCP) may exceed the AN PDB or packet discard timer, and the UL transmission cannot satisfy the service requirement.

And, based on the current specification, PDB, CN PDB, PSDB, and CN PSDB are configured per QoS flow, a packet discard timer is configured per DRB, but BSR is reported per logical channel group (LCG), and one LCG may include multiple logical channels, and multiple QoS flows and/or multiple DRBs can be mapped to one logical channel. Therefore, even UE reports the remaining AN PDB per LCG, remaining AN PSDB per LCG or remaining packet discard time, the radio network element cannot decide which logical channel the remaining AN PDB, remaining AN PSDB per LCG or remaining packet discard time corresponds to. And UE cannot know the PDB for the non-Standardized 5QI case and cannot decide the remaining AN PDB.

This embodiment proposes examples to solve the above problems.

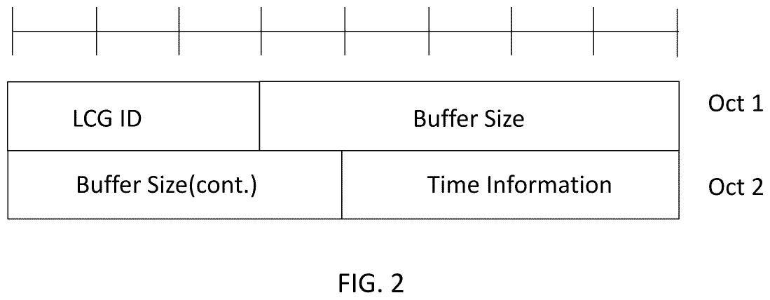

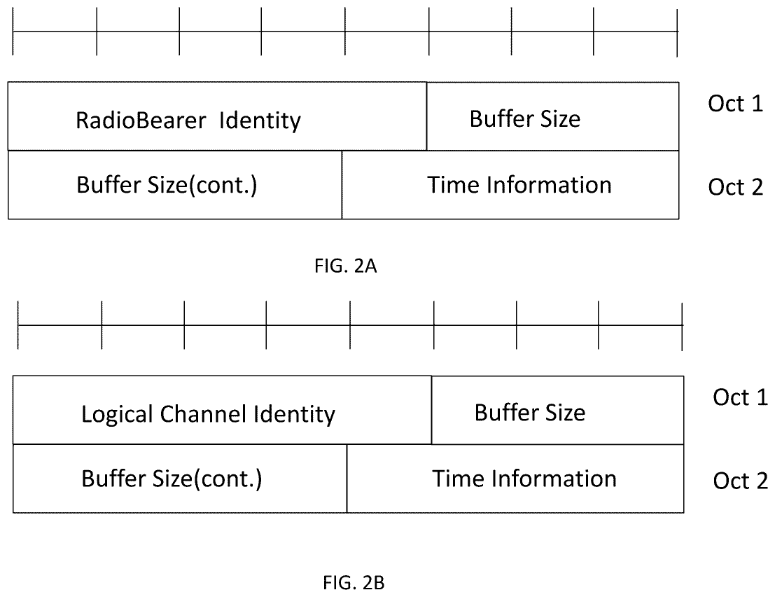

FIG. 2 shows an example of Buffer size and related time information report MAC CE

As disclosed in FIG. 2:

LCG ID, indicates the Logical Channel Group identity, which identifies the group of logical channel(s) that buffer status is being reported.

Buffer Size: identifies the amount of data available across all logical channels of a logical channel group after all MAC PDUs for the TTI have been built. The amount of data is indicated in number of bytes. It shall include data that is available for transmission in the RLC layer and in the PDCP layer corresponding to the time information; the buffer size level includes at least one of the following: the existing buffer size level, the interpolation existing buffer size levels for finer granularity, the TB size value(s), the multiple of TB size value(s)

Time Information: identifies the time that the Buffer Size is cached in UE, which includes at least one of the following: elapsed time since the packet(s) arrives at UE PDCP or PDCP upper SAP; the remaining time before the elapsed time since the packet(s) arrives at UE PDCP or PDCP upper SAP reaches the (AN) Packet delay budget; the remaining time before the packet discardTimer expires; the arriving time that the packet(s) arrives at UE PDCP or PDCP upper SAP; an immediate scheduling indication indicates whether the packet(s) corresponding to the buffer size should should be scheduled or transmitted immediately. a scheduling priority indication indicates whether the packet(s) corresponding to the buffer size should should be scheduled or transmitted with a higher priority, elapsed time since the PDU set(s) arrives at UE PDCP or PDCP upper SAP; the remaining time before the elapsed time since the PDU set(s) arrives at UE PDCP or PDCP upper SAP reaches the (AN) PDU set delay budget; the remaining time before the PDU set discardTimer expires; the arriving time that the PDU set(s) arrives at UE PDCP or PDCP upper SAP; an immediate scheduling indication indicates whether the PDU set(s) corresponding to the buffer size should should be scheduled or transmitted immediately. a scheduling priority indication indicates whether the PDU set(s) corresponding to the buffer size should should be scheduled or transmitted with a higher priority.

When (AN) Packet delay budget is used to decide the time information, and one LCG corresponds to multiple (AN) Packet delay budgets (e.g. multiple QoS flows with different (AN) Packet delay budgets are mapped to one LCG), the minimal value of the (AN) Packet delay budgets of the QoS flows mapped to the LCG is used to calculate the time information of the LCG.

When (AN) PDU set delay budget is used to decide the time information, and one LCG corresponds to multiple (AN) PDU set delay budgets (e.g., multiple QoS flows with different (AN) PDU set delay budgets are mapped to one LCG), the minimal value of the (AN) PDU set delay budgets of the QoS flows mapped to the LCG is used to calculate the time information of the LCG.

When a packet discardTimer is used to decide the time information, and one LCG corresponds to multiple packet discardTimers (e.g., multiple RadioBears are mapped to one LCG), the minimal value of the packet discardTimers of the radio bears mapped to the LCG is used to calculate the time information of the LCG.

When PDU set discardTimer is used to decide the time information, and one LCG corresponds to multiple PDU set discardTimers (e.g. multiple RadioBears are mapped to one LCG), the minimal value of the PDU set discardTimers of the radio bears mapped to the LCG is used to calculate the time information of the LCG.

When elapsed time or the remaining time is reported, considering the MAC CE (re) transmission delay, a reference timing should also be indicated, e.g. indicated explicitly by a reference SFN field or defined implicitly based on a pre-defined recent SFN (e.g. SFN0), and the time information is counted based on the SFN end boundary. The elapsed time or the remaining time can be a time duration (e.g., indicated by unit of ms, us, number of slots, number of subframes etc), a percent of (AN) packet delay budget, a percent of (AN) PDU set delay budget, a percent of packet discardTimer.

When arriving time is reported, it include at least one of the following information: the value of the least significant (the right most) 2 bits of Hyper SFN, the SFN (System Frame Number), the sub-SFN, the slot number.

When an immediate scheduling indication or scheduling priority indication is reported, it can be reported by an explicitly indicator field in the MAC CE, or implicitly by a predefined LogicalChannel ID in MAC header (e.g., the specific LogicalChannel ID is predefined for the higher priority buffer size reporting).

In the case that multiple PDUs belong to a PDU set, the PDU remaining time, PDU set elapsed time and PDU set delay budget is used for the remaining time or elapsed time calculation. Wherein the maximal elapsed time of the PDUs in the PDU set is used as the PDU set elapsed time, and the maximal remaining time of the PDUs in the PDU set is used as the PDU set remaining time. This rule is also used for all the invent (e.g. PDU set time replace the PDU time for time calculation when PDUs belong to a PDU set)

Where the bits number of each field in the MAC CE is only a example, it can be less or more. And oct number is also a example, and more oct may be used per MAC CE.

As disclosed in FIG. 2A:

The field information is same as that in FIG. 2, except that radio bearer identity is included in the Buffer size and related time information report MAC CE (e.g. LCG ID is replaced with radio bearer identity), which can report the Buffer size and related time information per radio bearer, e.g. with a finer granularity.

When (AN) Packet delay budget is used to decide the time information, and one radio bearer corresponds to multiple (AN) Packet delay budgets (e.g. multiple QoS flows with different (AN) Packet delay budgets are mapped to one radio bearer), the minimal value of the (AN) Packet delay budgets of the QoS flows mapped to the radio bearer is used to calculate the time information of the radio bearer.

When (AN) PDU set delay budget is used to decide the time information, and one radio bearer corresponds to multiple (AN) PDU set delay budgets (e.g. multiple QoS flows with different (AN) PDU set delay budgets are mapped to one radio bearer), the minimal value of the (AN) PDU set delay budgets of the QoS flows mapped to the radio bearer is used to calculate the time information of the radio bearer.

As disclosed in FIG. 2B:

The field information is same as that in FIG. 2, except that Logical channel identity is included in the Buffer size and related time information report MAC CE (LCG ID is replaced with Logical channel identity), which can report the Buffer size and related time information per logical channel, e.g. use more bits of the MAC CE and report the Buffer size and related time information with finer granularity.

When (AN) Packet delay budget is used to decide the time information, and one Logical channel corresponds to multiple (AN) Packet delay budgets (e.g., multiple QoS flows with different (AN) Packet delay budgets are mapped to one Logical channel), the minimal value of the (AN) Packet delay budgets of the QoS flows mapped to the Logical channel is used to calculate the time information of the Logical channel.

When (AN) PDU set delay budget is used to decide the time information, and one Logical channel corresponds to multiple (AN) PDU set delay budgets (e.g. multiple QoS flows with different (AN) PDU set delay budgets are mapped to one Logical channel), the minimal value of the (AN) PDU set delay budgets of the QoS flows mapped to the Logical channel is used to calculate the time information of the Logical channel.

When packet discardTimer is used to decide the time information, and one Logical channel corresponds to multiple packet discardTimers (e.g. multiple radio bears are mapped to one Logical channel), the minimal value of the packet discardTimers of the radio bears mapped the logical channel is used to calculate the time information of the logical channel.

When PDU set discardTimer is used to decide the time information, and one logical channel corresponds to multiple PDU set discardTimers (e.g. multiple RadioBears are mapped to one logical channel), the minimal value of the PDU set discardTimers of the radio bears mapped the logical channel is used to calculate the time information of the logical channel.

### Embodiment 2

This section discloses examples involving when a UE receives the UL grant, and there are multiple logical channels with data to be transmitted, how the UE should prioritize the logical channels (Logical Channel Prioritization, LCP) and select the one or more logical channels with data to transmit.

Multiple examples considering PDB or discard timer with relative priority are disclosed for LCP enhancement.

This embodiment is related to the previous embodiments.

The Logical Channel Prioritization (LCP) procedure is applied whenever a new transmission is performed.

RRC controls the scheduling of uplink data by signalling for each logical channel per MAC entity:
priority where an increasing priority value indicates a lower priority level;
prioritisedBitRate which sets the Prioritized Bit Rate (PBR);
bucketSizeDuration which sets the Bucket Size Duration (BSD).

The following UE variable is used for the Logical channel prioritization procedure:
Bj which is maintained for each logical channel j.

The MAC entity shall initialize Bj of the logical channel to zero when the logical channel is established.

For each logical channel j, the MAC entity shall:
1>increment Bj by the product PBR×T×1/remainingT before every instance of the LCP procedure, where T is the time elapsed since Bj was last incremented; and the remainingT is the remaining time before the elapsed time since the packet(s) arrives at UE PDCP or PDCP upper SAP reaches the (AN) Packet delay budget, the remaining time before the elapsed time since the PDU set(s) arrives at UE PDCP or PDCP upper SAP reaches the (AN) PDU set delay budget, the remaining time before the packet discardTimer expires, or the remaining time before the PDU set discardTimer expires.
1> if the value of Bj is greater than the bucket size (i.e. PBR×BSD):
   2> set Bj to the bucket size.

The MAC entity shall, when a new transmission is performed:
1>allocate resources to the logical channels as follows:
   2>logical channels selected in clause 5.4.3.1.2 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s);
   2>decrement Bj by the total size of MAC SDUs served to logical channel j above.

### Embodiment 3

This section discloses examples involving when a UE receives the UL grant, and there are multiple logical channels with data to be transmitted, how the UE should prioritize the logical channels (Logical Channel Prioritization, LCP) and select the one or more logical channels with data to transmit.

In particular, multiple examples of absolute priority schemes are disclosed regarding PDB or discard timer for LCP enhancement.

This embodiment is related to the previous embodiments.

The Logical Channel Prioritization (LCP) procedure is applied whenever a new transmission is performed.

RRC controls the scheduling of uplink data by signalling for each logical channel per MAC entity:
priority where an increasing priority value indicates a lower priority level;
prioritisedBitRate which sets the Prioritized Bit Rate (PBR);
bucketSizeDuration which sets the Bucket Size Duration (BSD);
lcpTimeThreshold which sets time threshold for LCP decision.

When the remainingT is equal to or less than the lcpTimeThreshold, the MAC will select logical channel with highest priority. Wherein the remainingT is the remaining time before the elapsed time since the packet(s) arrives at UE PDCP or PDCP upper SAP reaches the (AN) Packet delay budget, or the remaining time before the PDCP discardTimer expires, or the PDU set remaining time.

The following UE variable is used for the Logical channel prioritization procedure:
Bj which is maintained for each logical channel j.

The MAC entity shall initialize Bj of the logical channel to zero when the logical channel is established.

For each logical channel j, the MAC entity shall:
1>increment Bj by the product PBR×T before every instance of the LCP procedure, where T is the time elapsed since Bj was last incremented;
1> if the value of Bj is greater than the bucket size (i.e. PBR×BSD):
   2> set Bj to the bucket size.

The MAC entity shall, when a new transmission is performed:
1>allocate resources to the logical channels as follows:
   2>logical channels selected in clause 5.4.3.1.2 for the UL grant with Bj>0 are allocated resources in a decreasing priority order.

If remainingT is equal to or less than the lcpTimeThreshold, the MAC entity shall allocate resources for the data with the remainingT equal to or less than the lcpTimeThreshold for transmission on the logical channel firstly.

If some PDU is transmitted successfully, the MAC entity shall allocate resources for the data in the PDU set with some PDU(s) transmitted successfully for transmission on the logical channel firstly; If a PDU set is transmitted successfully, the MAC entity shall allocate resources for the PDU set for transmission on the logical channel firstly which are dependent by the PDU set transmitted successfully.

If the PBR of a logical channel is set to infinity, the MAC entity shall allocate resources for all the data that is available for transmission on the logical channel before meeting the PBR of the lower priority logical channel(s);
2>decrement Bj by the total size of MAC SDUs served to logical channel j above;

### Embodiment 4

This section discloses examples involving transmission procedure for PDB, PSDB, or LCP time threshold delivery.

This embodiment is related to the previous embodiments.

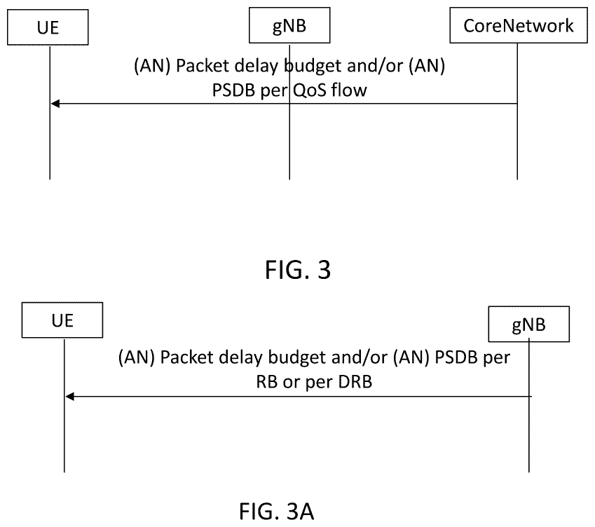

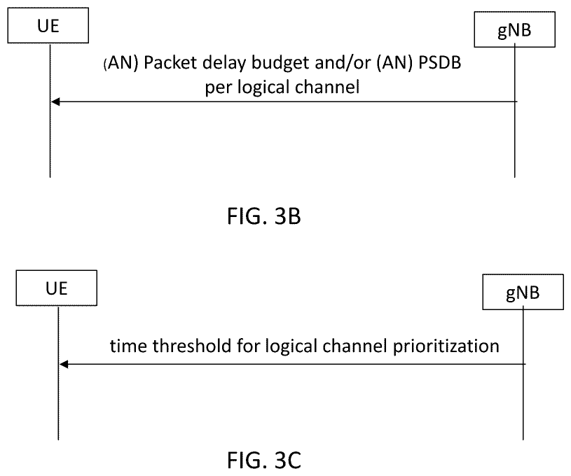

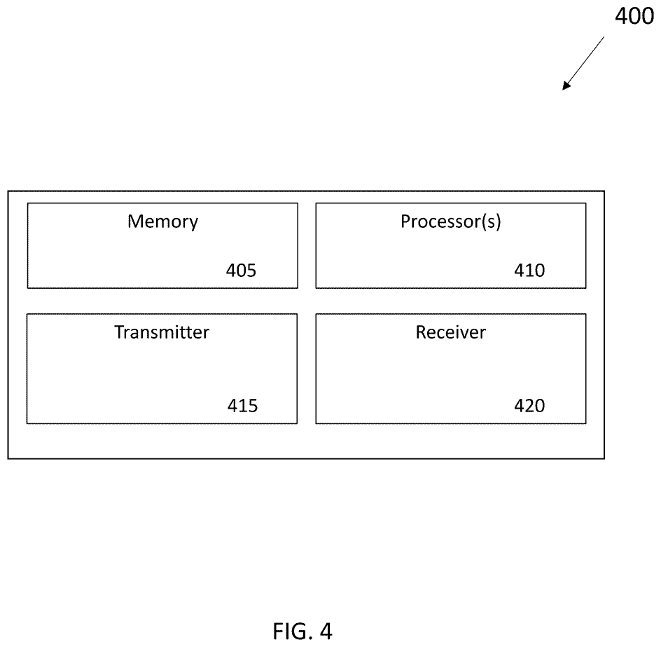

FIG. 3 shows an example of (AN) packet delay budget and/or PDU set delay budget is delivered from CoreNetwork to UE.

As shown in FIG. 3, packet delay budget, AN packet delay budget, PDU set delay budget (PSDB), and/or AN PDU set delay budget is sent from core network to UE by NAS for UE to evaluate the remaining time before the elapsed time since the packet(s) arrives at UE PDCP or PDCP upper SAP reaches the (AN) Packet delay budget (as shown in FIG. 2, FIG. 2-1, and FIG. 2-2) or perform logical channel prioritization based on the packet delay budget in embodiment 2 and embodiment 3.

Wherein the packet delay budget or AN packet delay budget is PDU set delay budget or AN PDU set delay budget.

As shown in FIG. 3A, packet delay budget, AN packet delay budget, PDU set delay budget (PSDB), and/or AN PDU set delay budget per RB or per DRB is sent from gNB to UE by RRC signalling, e.g. packet delay budget or AN packet delay budget is included RadioBearerConfig IE, in SDAP-Config IE, or in DRB-ToAddMod IE.

Which is used for UE to evaluate the remaining time before the elapsed time since the packet(s) arrives at UE PDCP or PDCP upper SAP reaches the (AN) Packet delay budget (as shown in FIG. 2, FIG. 2-1, and FIG. 2-2) or perform logical channel prioritization based on the packet delay budget in embodiment 2 and embodiment 3.

As shown in FIG. 3B, packet delay budget, AN packet delay budget, PDU set delay budget (PSDB), and/or AN PDU set delay budget per logical channel is sent from gNB to UE by RRC signaling, e.g., packet delay budget or AN packet delay budget is included in LogicalChannelConfig IE. These can be used for UE to evaluate the remaining time before the elapsed time since the packet(s) arrives at UE PDCP or PDCP upper SAP reaches the (AN) Packet delay budget (as shown in FIG. 2, FIG. 2A, and FIG. 2B) or perform logical channel prioritization based on the packet delay budget in embodiment 2 and embodiment 3.

As shown in FIG. 3C, time threshold for logical channel prioritization (lcpTimeThreshold) is sent from gNB to UE by RRC signaling, e.g., time threshold for logical channel prioritization (lcpTimeThreshold) is included LogicalChannelConfig IE. These can be used for UE to determine the logical channel priority in LCP procedure in embodiment 3.

### Embodiment 5

This section discloses examples involving examples related to a UE determining channel transmission priority based on the received information.

This embodiment is related to the previous embodiments.

In this embodiment, the logicalChannelID, LCG ID or DRB ID is included in the PDCCH DCI for UL grant to indicate explicitly that the UL grant is used for in indicated logicalChannelID, LCG ID or DRB ID with highest priority.

For example, if a logicalChannelID is included in the PDCCH DCI which includes UL grant, the MAC entity of the UE shall firstly allocate resources for packet or PDU set for transmission on the logical channel with the logicalChannelID included in the DCI; if a LCG ID is included in the PDCCH DCI which includes UL grant, the MAC entity of the UE shall firstly allocate resources for packet or PDU set for transmission on the logical channel(s) included in the LCG with the LCG ID included in the DCI; if a DRB ID is included in the PDCCH DCI which includes UL grant, the MAC entity of the UE shall firstly allocate resources for packet or PDU set for transmission on the logical channel(s) corresponding to the DRB with the DRB ID included in the DCI

### Embodiment 6

This section discloses examples involving methods involving UE capability report.

In the rel-17 NB-IoT, eMTC and NR specification, NTN (Non-Terrestrial Network) is supported, Thus, UE may support both TN and NTN, e.g. the UE can access to TN cell or access to NTN cell, but the radio capability may be different, e.g. the UE support some features in TN, but not support the features in NTN.

Generally, UE will report it's radio capability in TN; To distinguish the UE radio capability between TN and NTN, one possible way is UE report both it's TN radio capability and NTN radio capability.

Considering that although some features capability are different between TN and NTN for the same UE, most features capability are same in TN and NTN for the same UE. Thus, if the UE reports it's whole TN radio capability and whole NTN radio capability simultaneously, the payload of UE radio capability reporting will be large and common feature capabilities information (e.g. both supported in TN and NTN, or neither support in NTN nor support in TN) are redundant.

Usually, UE will report it's whole TN radio capability, one optimized way to report it's TN and NTN capability is:

If the feature apply in both TN and NTN, and if a field of radio capability for NTN is not included in the NTN radio capability IE, then the same field of radio capability for TN in the TN radio capability IE is also applied in NTN (e.g. for the feature that UE supports both in TN and NTN, or neither support in NTN nor support in TN, UE can report it's NTN radio capability implicitly with it's TN radio capability IE. That's, for the feature applicable in TN and NTN: if the feature capability field is not included in the NTN radio capability IE, the TN feature radio capability in the TN radio capability IE apply both in TN and NTN, if the feature capability field is included in the NTN radio capability IE, the feature capability field in the NTN radio capability IE only indicates it's NTN radio capability; for the feature applicable only in TN or NTN, the feature capability field in the NTN radio capability IE only indicates it's NTN radio capability, and the TN feature radio capability in the TN radio capability IE only indicates it's NTN radio capability). With this method, the payload of UE radio capability reporting can be reduced. This method can apply in any case that there are two IEs with the same sub-IEs, in which, when a sub-IE is not included in one IE, then the value of the same sub-IE in another IE will be apply in both IEs.

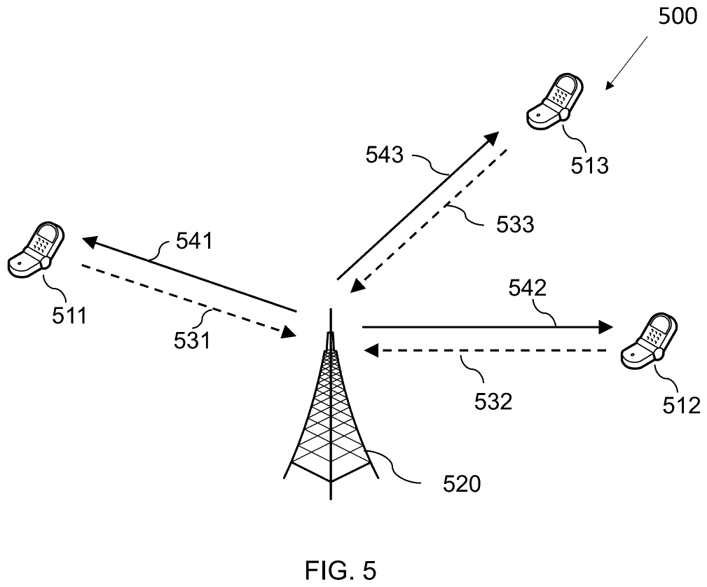

FIG. 4 shows an exemplary block diagram of a hardware platform 400 that may be a part of a network device (e.g., base station) or a communication device (e.g., a user equipment (UE)). The hardware platform 400 includes at least one processor 410 and a memory 405 having instructions stored thereupon. The instructions upon execution by the processor 410 configure the hardware platform 400 to perform the operations described in FIGS. 1 to 3 and in the various embodiments described in this patent document. The transmitter 415 transmits or sends information or data to another device. For example, a network device transmitter can send a message to user equipment. The receiver 420 receives information or data transmitted or sent by another device. For example, user equipment can receive a message from a network device.

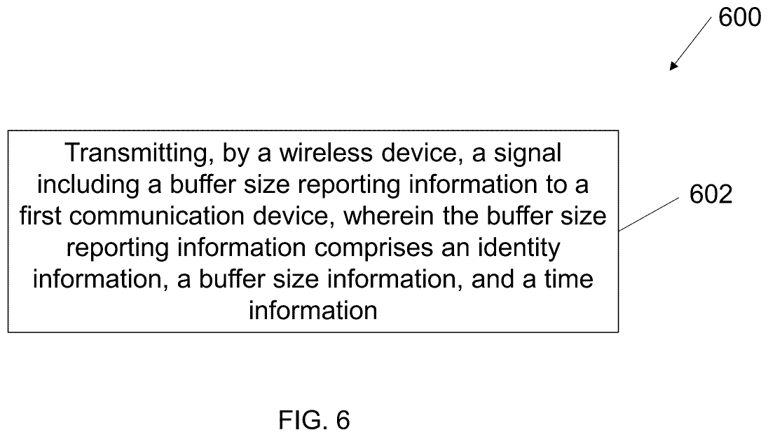

The implementations as discussed above will apply to a network communication. FIG. 5 shows an example of a communication system (e.g., a 5G or NR cellular network) that includes a base station 520 and one or more user equipment (UE) 511, 512 and 513. In some embodiments, the UEs access the BS (e.g., the network) using a communication link to the network (sometimes called uplink direction, as depicted by dashed arrows 531, 532, 533), which then enables subsequent communication (e.g., shown in the direction from the network to the UEs, sometimes called downlink direction, shown by arrows 541, 542, 543) from the BS to the UEs. In some embodiments, the BS send information to the UEs (sometimes called downlink direction, as depicted by arrows 541, 542, 543), which then enables subsequent communication (e.g., shown in the direction from the UEs to the BS, sometimes called uplink direction, shown by dashed arrows 531, 532, 533) from the UEs to the BS. The UE may be, for example, a smartphone, a tablet, a mobile computer, a machine to machine (M2M) device, an Internet of Things (IoT) device, and so on.

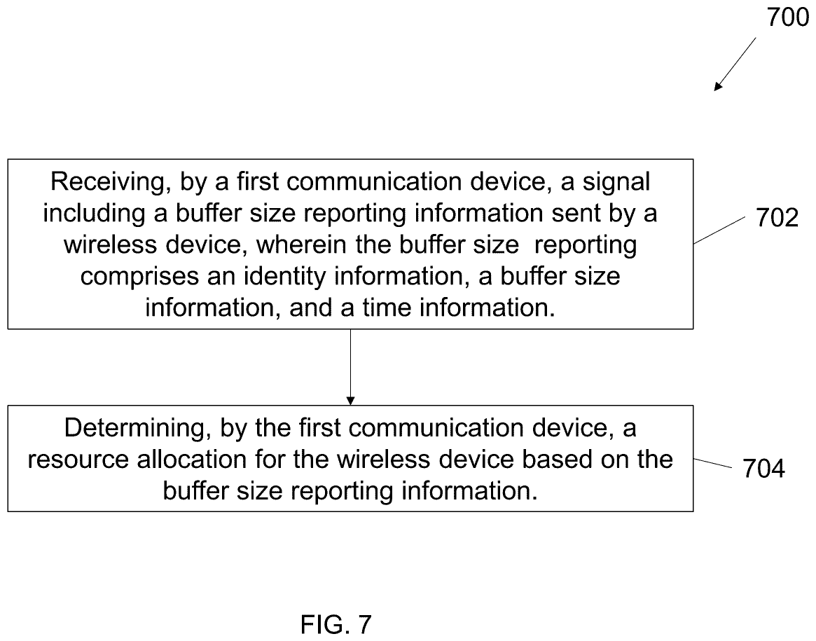

FIG. 6 shows an example flowchart representation of a method for digital communication in accordance with one or more embodiments of the present technology. Operation 602 includes transmitting, by a wireless device, a signal including a buffer size reporting information to a first communication device, wherein the buffer size reporting information comprises an identity information, a buffer size information, and a time information.

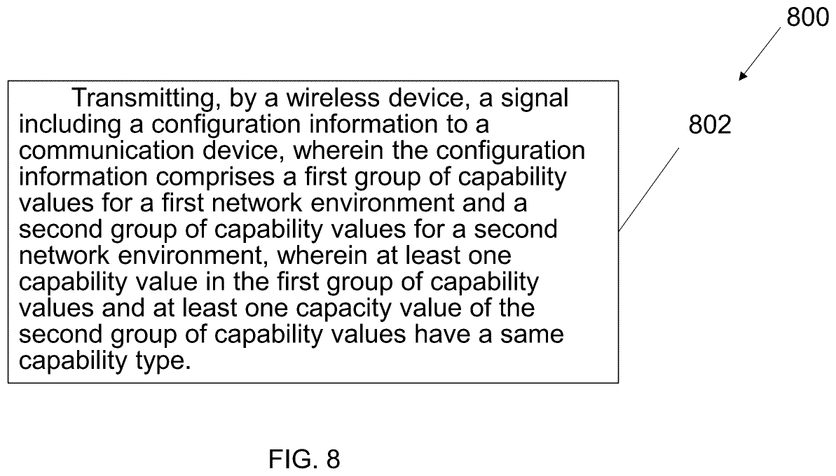

FIG. 7 shows another example flowchart representation of a method for digital communication in accordance with one or more embodiments of the present technology Operation 702 includes receiving, by a first communication device, a signal including a buffer size reporting information sent by a wireless device, wherein the buffer size reporting comprises an identity information, a buffer size information, and a time information. Operation 704 includes determining, by the first communication device, a resource allocation for the wireless device based on the buffer size reporting information

FIG. 8 shows another example flowchart representation of a method for digital communication in accordance with one or more embodiments of the present technology Operation 802 includes transmitting, by a wireless device, a signal including a configuration information to a communication device, wherein the configuration information comprises a first group of capability indications for a first network environment and a second group of capability indications for a second network environment, wherein at least one capability indication in the first group of capability indications and at least one capacity indication of the second group of capability indications indicate a same feature capability.

Various preferred embodiments and additional features of the above-described methods of FIGS. 6-8 are as follows. Further examples are described with reference to embodiments 1 to 6.

In some embodiments, the buffer size report information includes at least one of: 1) an existing buffer size level, 2) an interpolation existing buffer size levels for a finer granularity, 3) TB size value(s), or 4) multiple TB size value(s).

In some embodiments, the time information includes at least one of: 1) an elapsed time since a packet arrives at the first wireless device, 2) a remaining time before an elapsed time since a packet arrives at the wireless device reaches a delay budget, 3) a remaining time before an expire time limit, 4) an arriving time a packet arrives at the wireless device, 5) an indication indicates whether a packet corresponding to a buffer size should be scheduled or transmitted immediately, 6) an elapsed time since a packet data unit (PDU) set arrives at the first wireless device; 7) a remaining time before an elapsed time since a PDU set arrives at the wireless device reaches a delay budget, or 8) an arriving time a PDU set arrives at the wireless device, 9) an indication indicates whether a PDU set corresponding to a buffer size should be scheduled or transmitted immediately.

In some embodiments, the identity information is at least one of 1) Logical Channel Group (LCG) identity, 2) RadioBearer identity or 3) Logical Channel Identity.

In some embodiments, the buffer size information indicates an amount of data available for all logical channels mapped to the identity information corresponding to the time information.

In some embodiments, the above methods further comprising receiving a second configuration information by the wireless device from a second communication device.

In some embodiments, the second communication device is at least one of: 1) gNB or 2) Core Network

In some embodiments, the second configuration information comprises at least one of: 1) packet delay budget, 2) Access Network (AN) packet delay budget, 3) packet data unit (PDU) set delay budget, or 4) AN PDU set delay budget.

In some embodiments, the second configuration information is based on at least one of 1) quality of service (QOS) flow, 2) data radio bearer (DRB) or 3) logical channel

Another method for wireless communication is disclosed comprising: transmitting, by a wireless device, a signal including a configuration information to a communication device, wherein the configuration information comprises a first group of capability indications for a first network environment and a second group of capability indications for a second network environment, wherein at least one capability indication in the first group of capability indications and at least one capacity indication of the second group of capability indications indicate a same feature capability

In some embodiments, the procedure comprises determining an increment for a transmission resource, wherein the increment depends on an index indicating a remaining time for a transmission to complete.

In some embodiments, the increment further depends on a time elapse indicating 1) a remaining time before the elapsed time since a packet arrives at the wireless device reaches a delay budget, 2) the remaining time before a discard time limit, or 3) a pre-determined remaining time.

In some embodiments, the increment is determined by prioritized Bit Rate (PBR)×T×1/remainingT, wherein, PBR is a prioritized bit rate configured by the communication device, wherein T is the time elapsed since the increment was last incremented; wherein remainingT is a 1) remaining time before the elapsed time since a packet arrives at the wireless device, 2) a remaining time before discard time limit, or 3) a pre-determined remaining time.

In some embodiments, the procedure comprises setting a transmission resource of a highest transmission priority based on an index indicating a remaining time for a transmission to complete and a threshold, wherein the remaining time is equal to or less than a pre-determined remaining time threshold.

In some embodiments, the remaining time is at least one of 1) a remaining time before an elapsed time since a packet arrives at the wireless device reaches a delay budget, 2) the remaining time before a discard time limit, or 3) a pre-determined remaining time.

In some embodiments, the threshold is sent to the wireless device from the communication device through a signaling.

In some embodiments, the procedure comprises setting a priority for a transmission resource in the transmission resources based on identity information received by the wireless device from the communication device.

In some embodiments, the identity information is at least one of 1) logicalChannelID, 2) logical channel group (LCG) ID or 3) data radio bearer (DRB) ID

Another method for wireless communication is disclosed comprising: transmitting, by a wireless device, a signal including a configuration information to a communication device, wherein the configuration information comprises a first group of capability indications for a first network environment and a second group of capability indications for a second network environment, wherein at least one capability indication in the first group of capability indications and at least one capacity indication of the second group of capability indications indicate a same feature capability.

In some embodiments, the first network environment is a terrestrial network (TN).

In some embodiments, the second network environment is a non-terrestrial network (NTN).

In some embodiments, a capability indication in the first group of capabilities is applied to the second group of capabilities when a corresponding capability indication in the second group of capabilities is not included; wherein a capability indication in the second group of capabilities is applied to the second group of capabilities when the capability indication in the second group of capabilities is included.

It will be appreciated that the present document discloses methods and apparatus related to report buffer size and related delay budget information in wireless communication systems. In a radio communication system, e.g., LTE, NR or 6G system, core network may send multiple delay budget to radio network element (e.g., eNB, gNB). The delay budget may include: Packet delay budget (PDB), Core Network Packet Delay Budget (CN PDB), PDU set delay budget (PSDB), and Core Network PDU set delay budget (CN PSDB). Based on the PDB and CN PDB, 5G Access Network Packet Delay Budget (5G-AN PDB) can be determined. Similarly, 5G Access Network Packet Delay Budget (5G-AN PSDB) can be determined by PSDB minus CN PDDB. Under the existing systems, when radio network element allocates UL grant for the UE, the radio network element cannot know how long time the UL packet is buffered before sending the BSR and remaining AN PDB can be used for the transmission, which may cause unnecessary delay and inefficiency in communication. Also, based on the current specification, PDB and CN PDB are configured per QoS flow, but BSR is reported per logical channel group (LCG), and one LCG may include multiple logical channels. Thus, even UE reports the remaining AN PDB per LCG, the radio network element cannot decide which logical channel the remaining AN PDB corresponds to. And UE cannot know the PDB for the non-Standardized 5QI case and cannot decide the remaining AN PDB.

Furthermore, when receiving the UL grant, the UE should prioritize the logical channels (Logical Channel Prioritization, LCP) and select the one or more logical channels with data to transmit. Based on the current specification, only PBR (Prioritized Bit Rate) and the elapsed time that the data is buffered in UE, the remaining PDB is not considered, which may cause delay and inefficiency in the communication process. This application propose multiple methods to overcome the above issues.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
transmitting, by a wireless device, a signal including a buffer size reporting information to a first communication device, wherein the buffer size reporting information comprises an identity information, a buffer size information, and a time information.

2. The method of claim 1, wherein the buffer size report information includes at least one of: 1) an existing buffer size level, 2) an interpolation existing buffer size levels for a finer granularity, 3) TB size value(s), or 4) multiple TB size value(s).

3. The method of claim 1, wherein the time information includes at least one of: 1) an elapsed time since a packet arrives at the wireless device, 2) a remaining time before the elapsed time since the packet arrives at the wireless device reaches a first delay budget, 3) a remaining time before an expire time limit, 4) an arriving time when the packet arrives at the wireless device, 5) an indication that indicates whether the packet corresponding to a buffer size should be scheduled or transmitted immediately, 6) an elapsed time since a packet data unit (PDU) set arrives at the wireless device; 7) a remaining time before the elapsed time since the PDU set arrives at the wireless device reaches a second delay budget, 8) an arriving time when the PDU set arrives at the wireless device, or 9) an indication that indicates whether the PDU set corresponding to the buffer size should be scheduled or transmitted immediately.

4. The method of claim 1, wherein the identity information is at least one of 1) Logical Channel Group (LCG) identity, 2) RadioBearer identity, or 3) Logical Channel Identity.

5. The method of claim 1, wherein the buffer size information indicates an amount of data available for all logical channels mapped to the identity information corresponding to the time information.

6. The method of claim 1, further comprising receiving a second configuration information by the wireless device from a second communication device.

7. The method of claim 6, wherein the second communication device is at least one of: 1) gNB, or 2) Core Network.

8. The method of claim 6, wherein the second configuration information comprises at least one of: 1) packet delay budget, 2) Access Network (AN) packet delay budget, 3) packet data unit (PDU) set delay budget, or 4) AN PDU set delay budget.

9. The method of claim 6, wherein the second configuration information is based on at least one of 1) quality of service (QOS) flow, 2) data radio bearer (DRB), or 3) logical channel.

10. A method for digital communication, comprising:
receiving, by a first communication device, a signal including a buffer size reporting information from a wireless device, wherein the buffer size reporting information comprises an identity information, a buffer size information, and a time information; and
determining, by the first communication device, a resource allocation for the wireless device based on the buffer size reporting information.

11. The method of claim 10, wherein the buffer size report information includes at least one of: 1) an existing buffer size level, 2) an interpolation existing buffer size levels for a finer granularity, 3) TB size value(s), or 4) multiple TB size value(s).

12. The method of claim 10, wherein the time information includes at least one of: 1) an elapsed time since a packet arrives at the wireless device, 2) a remaining time before the elapsed time since the packet arrives at the wireless device reaches a first delay budget, 3) a remaining time before an expire time limit, 4) an arriving time when the packet arrives at the wireless device, 5) an indication that indicates whether the packet corresponding to a buffer size should be scheduled or transmitted immediately, 6) an elapsed time since a packet data unit (PDU) set arrives at the wireless device; 7) a remaining time before the elapsed time since the PDU set arrives at the wireless device reaches a second delay budget, 8) an arriving time when the PDU set arrives at the wireless device, or 9) an indication that indicates whether the PDU set corresponding to the buffer size should be scheduled or transmitted immediately.

13. The method of claim 10, wherein the identity information is at least one of 1) Logical Channel Group (LCG) identity, 2) RadioBearer identity, or 3) Logical Channel. Identity.

14. The method of claim 10, wherein the buffer size information indicates an amount of data available for all logical channels mapped to the identity information corresponding to the time information.

15. An apparatus for communication network, comprising: a processor configured to transmit a signal including a buffer size reporting information to a first communication device, wherein the buffer size reporting information comprises an identity information, a buffer size information, and a time information.

16. The apparatus of claim 15, wherein the buffer size report information includes at least one of: 1) an existing buffer size level, 2) an interpolation existing buffer size levels for a finer granularity, 3) TB size value(s), or 4) multiple TB size value(s).

17. The apparatus of claim 15, wherein the time information includes at least one of: 1) an elapsed time since a packet arrives at the wireless device, 2) a remaining time before the elapsed time since the packet arrives at the wireless device reaches a first delay budget, 3) a remaining time before an expire time limit, 4) an arriving time when the packet arrives at the wireless device, 5) an indication that indicates whether the packet corresponding to a buffer size should be scheduled or transmitted immediately, 6) an elapsed time since a packet data unit (PDU) set arrives at the wireless device; 7) a remaining time before the elapsed time since the PDU set arrives at the wireless device reaches a second delay budget, 8) an arriving time when the PDU set arrives at the wireless device, or 9) an indication that indicates whether the PDU set corresponding to the buffer size should be scheduled or transmitted immediately.

18. The apparatus of claim 15, wherein the identity information is at least one of 1) Logical Channel Group (LCG) identity, 2) RadioBearer identity, or 3) Logical Channel Identity.

19. The apparatus of claim 15, wherein the buffer size information indicates an amount of data available for all logical channels mapped to the identity information corresponding to the time information.

20. The apparatus of claim 15, wherein the processor is further configured to receive a second configuration information from a second communication device, wherein the second communication device is at least one of: 1) gNB, or 2) Core Network.
